(19) United States
(12) Patent Application Publication
(10) Pub. No.: US 2026/0261862 A1
(43) Pub. Date: Sep. 3, 2026

(54) COMPUTER SYSTEM AND METHOD FOR EVIDENCE PRESERVATION IN MOBILE DEVICE DIGITAL FORENSIC INVESTIGATIONS

(71) Applicant: Magnet Forensics Inc., Waterloo (CA)

(72) Inventors: Joanna Doute, Portland, ME (US); Braden Thomas, Milton, GA (US); Cyrus Malekpour, Charlottesville, VA (US); Edgar Pek, St. Charles, IL (US)

(21) Appl. No.: 19/554,968

(22) Filed: Mar. 3, 2026

Related U.S. Application Data
(60) Provisional application No. 63/766,117, filed on Mar. 3, 2025.

(51) Int. Cl. H04W 12/37

(52) U.S. Cl. CPC H04W 12/37

(57) ABSTRACT

A system and method for providing evidence preservation on mobile devices are provided The system may include an investigator device comprising at least one memory storing processor-executable instructions, and at least one processor communicatively coupled to the memory, the processor configured to execute the processor-executable instructions, the at least one processor including an access module operable to connect the investigator device to a target mobile device, wherein the target mobile device stores target mobile device data, and an evidence preservation module to activate an evidence preservation mode on the target mobile device, wherein evidence preservation mode preserves at least a portion of the data of the target mobile device in a current configuration.

### TECHNICAL FIELD

The following relates generally to digital forensics, and more particularly to systems and methods for preserving access to and availability of evidence to be retrieved or extracted from mobile devices.

### BACKGROUND

Advancements in smartphone security and encryption introduce additional challenges for law enforcement. Mobile devices are often a source for evidence but gathering this evidence is difficult. Acquiring evidence is time-consuming due to the actual amount of time to access the device and retrieve and parse information as well as in terms of the amount of time required to be granted permission to access the device by a governing body. That is, although a mobile device may be physically available for an investigation, a warrant or other legal permission may not be readily available.

The introduction of features or applications which restart a smartphone when the phone has not been accessed for a certain amount of time adds a new challenge for digital forensic investigations as restarting or shutting down a device results in the loss of and/or changes to data and metadata as well as making it more difficult to access the device.

Data may also be lost if a device is remotely wiped, a software update occurs, data is automatically deleted (e.g., automatic removal of old deleted items), etc. However, there are currently no effective means to retain a mobile device or its data in a current state.

Accordingly, there is a need for systems and methods that overcome these disadvantages to allow for evidence preservation of a mobile device until such time as an investigation can be carried out.

### SUMMARY

Provided herein is a system for providing evidence preservation on mobile devices, the system including an investigator device comprising at least one memory storing processor-executable instructions, and at least one processor communicatively coupled to the memory, the processor configured to execute the processor-executable instructions, the at least one processor including an access module operable to connect the investigator device to a target mobile device, wherein the target mobile device stores target mobile device data, and an evidence preservation module to activate an evidence preservation mode on the target mobile device, wherein evidence preservation mode preserves at least a portion of the data of the target mobile device in a current configuration.

The evidence preservation mode may disable an inactivity timer or automatic reboot function.

The evidence preservation mode may prevent wiping of data from the target mobile device.

The evidence preservation mode may prevent software updates of the target mobile device.

The evidence preservation mode may prevent data expiration.

The access module and the evidence preservation module may not extract any data from the target mobile device.

The evidence preservation module may preserve the at least a portion of the data of the target mobile device in the current configuration by creating a copy of the at least a portion of the data and storing the copy on the target mobile device. The copy may be stored separately from the file system of the target mobile device.

The at least one processor may further include an extraction module operable to extract data from the target mobile device.

Provided herein is a method of preserving evidence on a mobile device, the method including establishing a connection between a target mobile device and an investigator device, and enabling an evidence preservation mode on the target mobile device by the investigator device, wherein the evidence preservation mode preserves at least a portion of target mobile device data in a current configuration.

Enabling the evidence preservation mode may include disabling an inactivity timer.

Enabling the evidence preservation mode may include disabling wiping of data from the target mobile device.

Enabling the evidence preservation mode may include disabling software updates of the target mobile device.

Enabling the evidence preservation mode may include disabling data expiration.

The method may further comprise creating a copy of the at least a portion of the data and storing the copy on the target mobile device. The copy may be stored separately from the file system of the target mobile device.

The method may further comprise extracting the preserved data from the target mobile device.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a system for performing evidence preservation on a target mobile device, according to an embodiment;

FIG. 2 is a block diagram of an example investigator computing device, according to an embodiment;

FIG. 3 is a schematic diagram of a system for evidence preservation including an investigator device and a target mobile device, according to an embodiment;

FIG. 4 is an example graphical user interface (GUI) element for entering a target mobile device into an evidence preservation mode, according to an embodiment;

FIG. 5 is a flow diagram of a method of placing a target mobile device into an evidence preservation mode, according to an embodiment;

FIG. 6 is a flow diagram of a method of determining which method of evidence preservation is suitable for a target mobile device, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of embodiments of the present invention.

Further, although process steps, method steps, algorithms or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates to digital forensics, and more particularly to systems and methods for processing digital forensic data in the computer-readable storage media of mobile devices (or other similar devices).

Provided herein are systems and methods for evidence preservation of a mobile device. The systems and methods are applied to mobile devices which are in the custody of an investigative body (e.g., law enforcement) and may possibly be the subject of a digital forensic investigations at a later time (e.g., if a warrant can be obtained for the investigation). The systems and methods described herein allow at least some of the evidence within the mobile device to be preserved in a current form. The advantages provided by said evidence preservation include preventing data loss due to data wipes and software updates, preserving aging data such as deleted images of Knowledge D databases, removing the need for a Faraday solution, removing the need for power banks to prevent the device turning off, and allowing for a future investigation to access preserved data at the time the phone was acquired. That is, the systems and methods described herein allow for preservation of at least the temporary files which are on a target mobile device which are at risk of being lost over time.

The systems and methods described herein allow for the generation of a partial or full copy of the file system of a target mobile device and storage of the copy on the target mobile device to ensure that no important data, data configurations, or metadata are lost.

Additionally, or alternatively where a file system copy cannot be created/stored, the systems and methods allow for re-configuring the target mobile device to prevent software updates, prevent deletion of temporary data (e.g. clearing of caches), block remote wipes, and disable inactivity timers or automatic reboots functions which shut down or restart the target mobile device.

Importantly, the systems and methods described herein, while requiring a connection to the mobile device, do not extract any data from the device and therefore the systems and methods may be usable before a warrant or similar legal authorization is acquired.

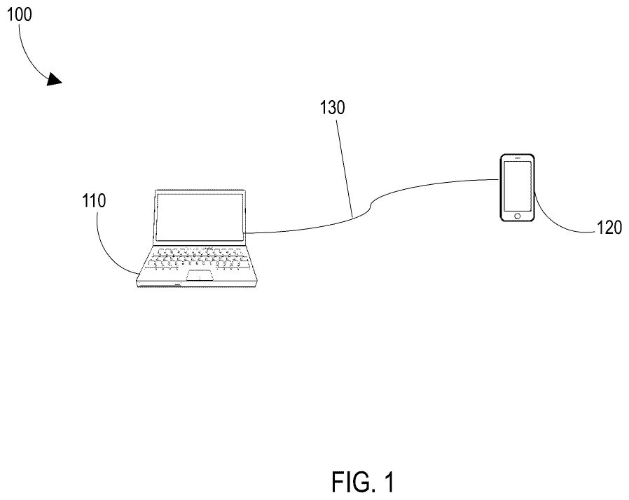

Referring now to FIG. 1, shown therein is a system 100 for preserving evidence on a mobile device, according to an embodiment. The system 100 includes an investigator computing device 110 which is communicatively couple-able to a target mobile device 120.

The investigator device 110 may include at least one computing device having at least one memory and at least one processor configured to execute instructions to preserve evidence on the target mobile device 120. The investigator device 110 may be the same device that extracts data from the target mobile device at a later time or may be a different device.

Examples of investigator devices include a laptop computer (shown in FIG. 1) and a desktop computer. The investigator device 110 may be connected to a server. In some embodiments, the investigator device 110 may be connected to a cloud computer system (e.g., a cloud service such as Amazon AWS).

The investigator device 110 may establishes a communicative connection 130 to the target mobile device 120. The connection may be a wired connection or a wireless connection. The wired connection may be a data transfer cable, such as a USB cable or the like.

The investigator device 110 may be powered by an operating system such as Windows 10, Android, iOS, or the like.

The target mobile device 120 may be any mobile device capable of storing data and data items, for example a smartphone or a tablet. The target mobile device 120 stores a target dataset which may include forensically relevant data items (“forensic dataset”).

The investigator device 110 and target mobile device 120 shown in FIG. 1 and discussed herein are meant to represent various embodiments of systems and connections for preserving evidence and performing a digital forensic investigation on a target mobile device. The same investigator device 100 may be used to preserve evidence from multiple different target mobile devices.

In some embodiments, an extraction computing device, for example as described in U.S. Pat. No. 12,182,153 (incorporated herein by reference), may be used in conjunction with the investigator device 100 to perform evidence preservation and any subsequent data extraction.

In some embodiments, an agent is deployed to the target mobile device 120 from the investigator device 110 to perform the functions of evidence preservation and/or data extraction.

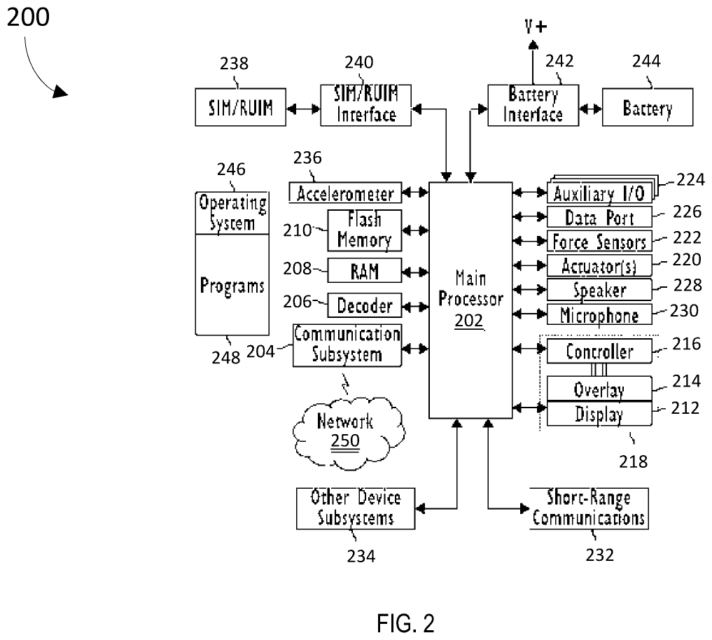

Referring now to FIG. 2, shown therein is a block diagram of an example investigator computing device 200, according to an embodiment. The computing device 200 may be, for example, investigator device 110 of FIG. 1.

The computing device 200 includes multiple components such as a processor 202 that controls the operations of the computing device 200. Communication functions, including data communications, voice communications, or both may be performed through a communication subsystem 204. Data received by the computing device 200 may be decompressed and decrypted by a decoder 206. The communication subsystem 204 may receive messages from and send messages to a wireless network 250.

The wireless network 250 may be any type of wireless network, including, but not limited to, data-centric wireless networks, voice-centric wireless networks, and dual-mode networks that support both voice and data communications.

The computing device 200 may be a battery-powered device and as shown includes a battery interface 242 for receiving one or more rechargeable batteries 244.

The processor 202 also interacts with additional subsystems such as a Random Access Memory (RAM) 208, a flash memory 210, a display 212 (e.g. with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface may be performed through the touch-sensitive overlay 214. The processor 202 may interact with the touch-sensitive overlay 214 via the electronic controller 216. Information, such as text, characters, symbols, images, icons, and other items that may be displayed or rendered on a computing device generated by the processor 202 may be displayed on the touch-sensitive display 218.

The processor 202 may also interact with an accelerometer 236 as shown in FIG. 2. The accelerometer 236 may be utilized for detecting direction of gravitational forces or gravity-induced reaction forces.

To identify a subscriber for network access according to the present embodiment, the computing device 200 may use a Subscriber Identity Module or a Removable User Identity Module (SIM/RUIM) card 238 inserted into a SIM/RUIM interface 240 for communication with a network (such as the wireless network 250). Alternatively, user identification information may be programmed into the flash memory 210 or performed using other techniques.

The computing device 200 also includes an operating system 246 and software components 248 that are executed by the processor 202 and which may be stored in a persistent data storage device such as the flash memory 210. Additional applications may be loaded onto the computing device 200 through the wireless network 250, the auxiliary I/O subsystem 224, the data port 226, the short-range communications subsystem 232, or any other suitable device subsystem 234.

In use, a received signal such as a text message, an e-mail message, web page download, or other data may be processed by the communication subsystem 204 and input to the processor 202. The processor 202 then processes the received signal for output to the display 212 or alternatively to the auxiliary I/O subsystem 224. A subscriber may also compose data items, such as e-mail messages, for example, which may be transmitted over the wireless network 250 through the communication subsystem 204.

For voice communications, the overall operation of the computing device 200 may be similar. The speaker 228 may output audible information converted from electrical signals, and the microphone 230 may convert audible information into electrical signals for processing.

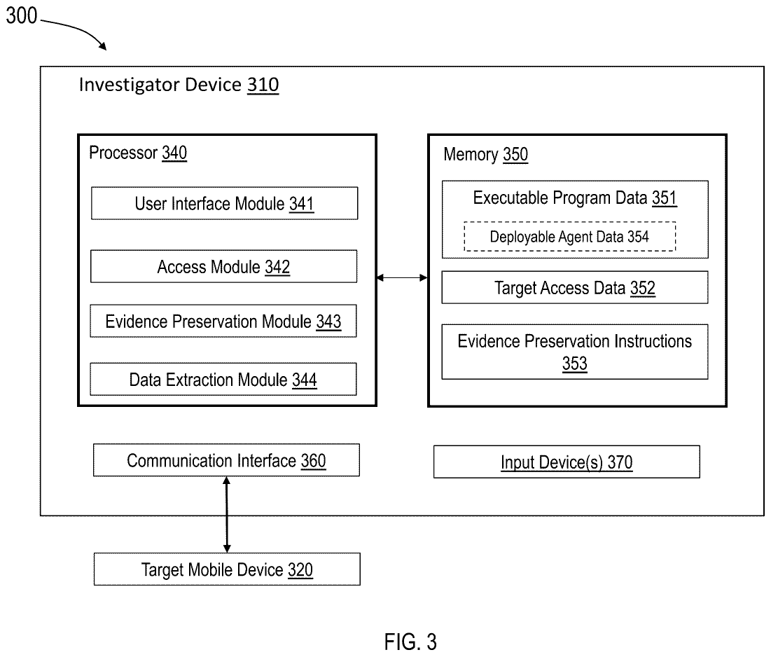

Referring now to FIG. 3, shown therein is a schematic diagram 300 of a system for evidence preservation of a target mobile device 320. The system includes an investigator device 310 and the target mobile device 320.

The investigator device 310 includes a processor 340, a memory 350, a communication interface 360, and at least one input device 370.

The at least one input device may include a keyboard, a mouse, a touchscreen, etc.

In some embodiments, processor 340 may include more than one processor. In some embodiments, memory 350 may include more than one memory and/or an external memory.

The processor 340 includes a user interface module 341, an access module 342, an evidence preservation module 343, and a data extraction module 344. Further modules and elements of the processor exist but are not described herein.

The memory 350 includes instructions for the processor in the form of executable program data 351, as well as target access data 352, evidence preservation instructions 353. The executable program data 351 may include deployable agent data 354.

The executable program data 351 provides instructions for the various modules of the investigator device 310. The target access data 352 provides data which is required to acquire access to a target mobile device. The evidence preservation instructions 353 provides the instructions and data required for the processor to place the target mobile device into an evidence preservation mode. The evidence preservation mode may be modified based on the situation and current target mobile device and, therefore, different evidence preservation instructions (and data) 353 may be used for a given situation.

The user interface module 341 executes executable program data 351 to generate a graphical user interface (GUI) for a digital forensic investigation program on a user interface (UI) of the investigator device 310 (e.g., a screen).

The access module 342 executes executable program data 351 and uses target access data 352 to establish a communicative connection to the target mobile device 320. The investigator device 310 and the target mobile device 320 may be connected through communication interface 360. The communication interface 360 may be a port on the investigator device 310 which allows a wired connection to the target mobile device 320.

In some embodiments, an extraction computing device may be connected to the target mobile device 320 and to the investigator device 310, which enables a user to acquire access to the target mobile device 320.

Once a connection between the investigator device 310 and the target mobile device 320 has been established, the evidence preservation module 343 executes the executable program data 351 and uses evidence preservation instructions 353 to cause the target mobile device 320 to enter an evidence preservation mode in which data is maintained in the current form and configuration. That is, the target mobile device 320 is put into a “stasis” which preserves evidence as it is at that moment in time.

The executable program data 351 may include deployable agent data 354, wherein the processor 340 executes the instructions to send a deployable agent to the target mobile device 320 to alter the configuration of the target mobile device 320 and place the target mobile device 320 into evidence preservation mode. The deployable agent may be deleted from the target mobile device 320 after the full or partial copy of the data is created or if evidence preservation mode is unsuccessful.

The evidence preservation mode may preserve data in a number of ways, including creating a partial or full copy of target mobile device data, and/or altering the configuration of the target mobile device by disabling automatic software updates, disabling automatic data deletion, and blocking remote data wipes. The evidence preservation mode may also disable an inactivity timer or automatic re-boot function to prevent shutting down or re-starting of the target mobile device, thus ensuring data is not lost.

Evidence preservation mode may create a partial or full copy of the data (herein also referred to as the “preserved data”) on the target mobile device 320 and save the copy on the target mobile device 320 itself. The preserved data includes temporary files that may be lost over time due to software updates, clearing of caches, re-starting of the device, etc. If all of the necessary data has been preserved in the partial or full copy saved on the target mobile device 320, altering the configuration of the target mobile device 320 to prevent software updates, prevent automatic data deletion, block remote wipes, and disable an inactivity timer may not be required, although they may be performed anyway.

Creating the partial or full copy of the data allows for the phone to continue running as usual or to be shut down, as loss of the original files or changes to the target mobile device 320 file system are no longer a concern, as the partial or full copy of the data is stored at a different level of the file system which will remain unaffected by changes to the target mobile device 320.

Entering the target mobile device 320 into the evidence preservation mode by the evidence preservation module 343 of the investigator device 310 does not extract any data from the target mobile device 320 and therefore may possibly (depending on jurisdiction) be performed without a warrant. That is, by storing the partial or full copy of the data of the target mobile device 320 on the target mobile device 320 itself, data is never removed from device 320 until such time as it is legally possible to do so.

Once it is legally possible to extract the desired data from the target mobile device 320, the data extraction module 344 executes the instructions in the executable program data 351 to extract data of interest from the target mobile device 320 including the partial or full copy of the data preserved by evidence preservation mode. The data of interest may be a full or partial copy of all of the data on the target mobile device 320, including data which was not preserved by evidence preservation mode.

As with evidence preservation module 342, in some embodiments, the data extraction module 354 may use deployable agent data 354 to send a deployable agent to the target mobile device 320 to extract the data or interest. The deployable agent may be deleted from the target mobile device 320 when data extraction is complete.

Because the preserved data is copied and stored on the target mobile device 320, preserving data is only possible if there is enough disk space. In a situation where there is not enough disk space, the configuration of the target mobile device 320 may still be altered to disable automatic software updates, disable automatic data deletion (e.g. cache clearing), block remote data wipes, and/or disable an inactivity timer or automatic reboot-function.

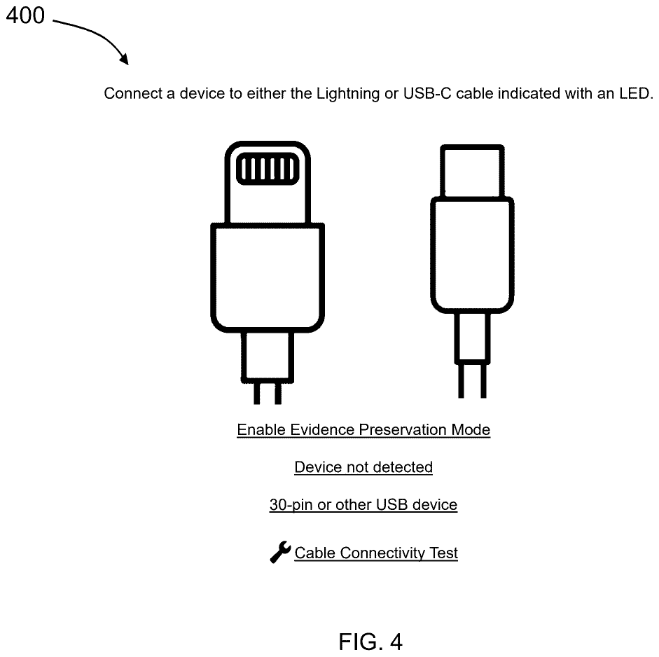

FIG. 4 is an example graphical user interface (GUI) element 400 for entering a target mobile device into an evidence preservation mode, as described herein. The GUI element 400 may be shown on a user interface of an investigator device to a user attempting to establish a connection to a target mobile device and place the target mobile device into an evidence preservation mode while awaiting authorization to perform a search/extraction.

The GUI element 400 may also be shown to a user establishing a connection to a target mobile device for extraction of data where evidence preservation mode is not required as authorization for an investigation has already been established. That is, the program (or hardware) which provides evidence preservation mode may be the same program that performs the investigation, wherein placing the phone into an evidence preservation mode may be an optional first step before a search/extraction.

Before the user establishes a connection to the target mobile device by plugging a connection wire into the target mobile device (or in other embodiments, wirelessly connecting to the device), the user may click the “Enable Evidence Preservation Mode” button/link to select evidence preservation mode. Once they have selected evidence preservation mode, the user may plug the connection wire into the target mobile device. Once a connection is established (e.g. by an access module as described above), the target mobile device is placed into evidence preservation mode, if possible.

When the target mobile device has been successfully placed into evidence preservation mode a message to that effect will be displayed on the user interface of the investigator device. The message will inform the user that evidence has been preserved, and may further inform the user of what can be done with the target mobile device. For example, the message may inform the user that the device can safely be powered down without risking loss of evidence, or that the device can be safely disconnected from the investigator device.

When the target mobile device cannot be placed into evidence preservation mode (e.g., there is not enough disk space on the target mobile device to store copied data), a message may be displayed that evidence preservation mode was unsuccessful.

When there is not enough space to perform a full evidence preservation, the target mobile device may be placed into an alternate evidence preservation mode where the configuration of the target mobile device is altered to prevent automatic software updates, prevent automatic data deletion (e.g. cache clearing), block remote data wipes, and/or disable an inactivity timer or automatic reboot-function. A message may indicate to the user that the target mobile device is in evidence preservation mode but that a partial or full copy of data (i.e. “preserved data”) was not generated. In this situation, the user would be informed that they should not turn off the device and that the device should be connected to a power source.

In an embodiment where the evidence preservation mode is performed by the same program/software as performs a search/extraction, the steps for establishing a connection may be the same for both the evidence preservation mode step and an investigation step, therefore, it is important to ensure that enabling evidence preservation mode prevents any data from being extracted from the target mobile device before appropriate authorizations have been received.

When a user receives an authorization to proceed with a search and/or extraction of data from the target mobile device, the user interface may show to the user a summary of the details of the evidence preservation mode.

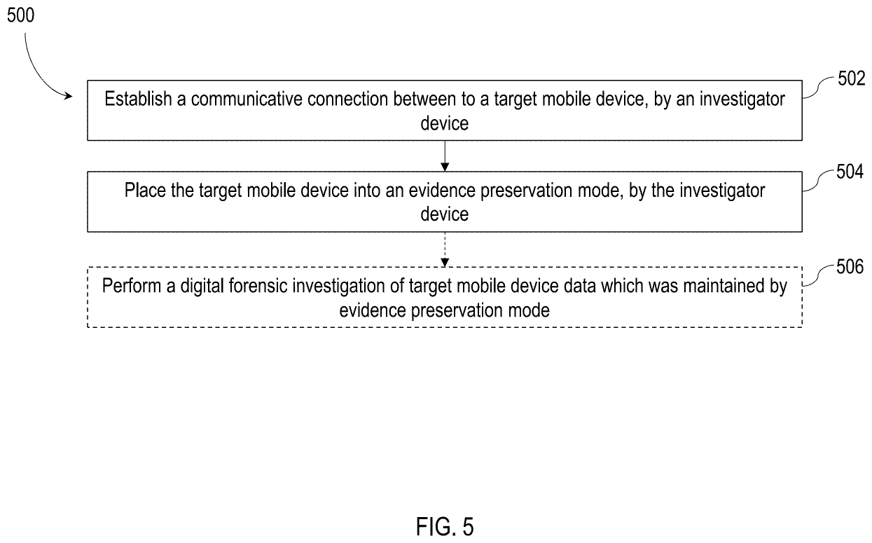

FIG. 5 is a flow diagram of a method 500 of placing a target mobile device into an evidence preservation mode.

At 502, a communicative connection is established between an investigator device (e.g., investigator device 110/310) and a target mobile device (e.g. target mobile device 120/320). The connection may be wireless or a wired connection. The connection provides access to the settings and data of the target mobile device to the investigator device.

At 504, the investigator device places the target mobile device into an evidence preservation mode which maintains the data and metadata of the target mobile device in a present configuration. That is, the evidence preservation mode prevents the loss of data and data configurations that exist at the time of connecting to the target mobile device. It is, therefore, beneficial to place the target mobile device into evidence preservation mode as soon as possible after acquiring the device.

The investigator device may deploy an agent to the target mobile device which acts within the mobile device to preserve evidence. The deployable agent may be deleted from the device once the evidence preservation mode is active.

Evidence preservation mode may perform a variety of functions to preserve data in a static configuration. The preferred method of data configuration is creating a partial or full copy of the data (i.e., the “preserved data) on the target mobile device. The copy may be a partial copy which includes at least the temporary data which is at risk of being lost or the copy may be a full copy of all data on the target mobile device. Whether the copy is a partial copy or a full copy may depend on the nature of the investigation or on the amount of disk space available on the target mobile device for storing the preserved data.

In a situation when there is not enough disk space to store preserved data the evidence preservation mode may instead include reconfiguration of the target mobile device to disable an inactivity timer which triggers a shutdown or restart, disable automatic software updates, disable automatic deletion of data, and block remote wipes. In some embodiments, reconfiguration of the device may occur even if preserved data can be stored on the target mobile device.

At 506, a digital forensic investigation which searches through and/or extracts data from the target mobile device in order to find evidence for an investigation is performed on the target mobile device data which has been maintained in the evidence preservation mode. Step 506 is shown in dashed lines, as step 506 may not occur if an authorization to perform the search is never obtained, and is not necessary for evidence preservation.

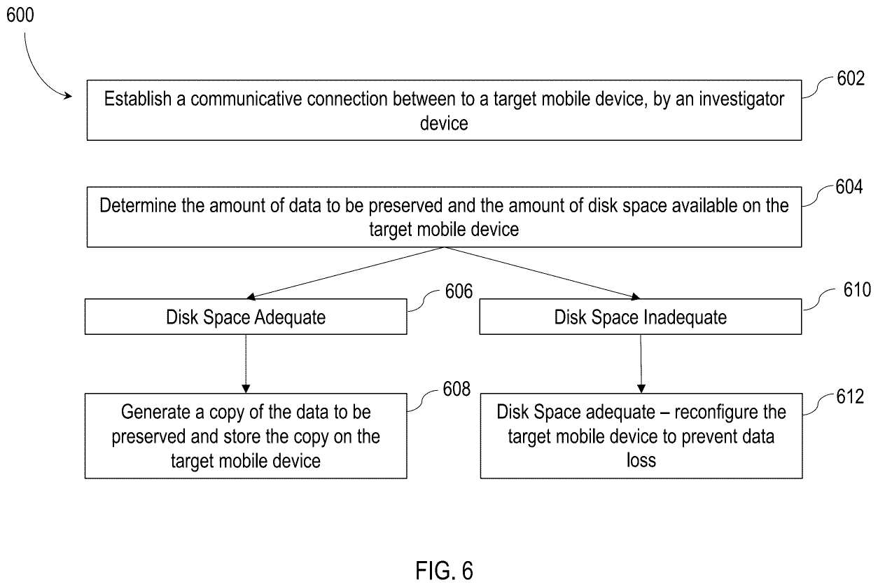

FIG. 6 is a flow diagram of a method 600 of determining which method of evidence preservation is suitable for a target mobile device.

At 602, a communicative connection is established between an investigator device (e.g., investigator device 110/310) and a target mobile device (e.g. target mobile device 120/320). The connection may be wireless or a wired connection. The connection provides access to the settings and data of the target mobile device to the investigator device.

At 604, the investigator device determines the amount of data which is present on the target mobile device which needs to be preserved as well as the available disk space on the target mobile device for storing preserved data. The data which needs to be preserved may be determined by checking the amount of data is specific folders or caches which will be lost if the phone shuts down, updates, or enough time passes that temporary data is cleared. The total amount of data which would be preserved if a full copy of the target mobile device data was created may also be calculated as in some situations a full copy may be desirable.

At 606, the amount of disk space is found to be adequate for the amount of data which needs to be preserved, based on the determined amount of data to be preserved. The disk space may be adequate for a full copy or just adequate for a partial copy.

At 608, when the disk space was found to be adequate a copy of the data to be preserved is generated and stored on the target mobile device.

At 610, the amount of disk space is not found to be adequate for storing the data to be preserved.

At 612, the investigator device reconfigures the target mobile device to disable an inactivity timer or automatic reboot function, disable software updates, disable automatic deletion of data, and/or to block remote wipes or access.

Optionally, at 608, the method may follow on to 612 to reconfigure the target mobile device as well as generating and storing the preserved data on the target mobile device. This may be preferable if only a partial copy of the target mobile device can be stored as the preserved data.

While the above description provides examples of one or more apparatus, methods, or systems, it will be appreciated that other apparatuses, methods, or systems may be within the scope of the claims as interpreted by one of skill in the art.

1. A system for providing evidence preservation on mobile devices, the system comprising:
an investigator device comprising:
at least one memory storing processor-executable instructions; and
at least one processor communicatively coupled to the memory, the processor configured to execute the processor-executable instructions, the at least one processor including:
an access module operable to connect the investigator device to a target mobile device, wherein the target mobile device stores target mobile device data; and
an evidence preservation module to activate an evidence preservation mode on the target mobile device, wherein evidence preservation mode preserves at least a portion of the data of the target mobile device in a current configuration.

2. The system of claim 1, wherein the evidence preservation mode disables an inactivity timer or automatic reboot function.

3. The system of claim 1, wherein the evidence preservation mode prevents wiping of data from the target mobile device.

4. The system of claim 1, wherein the evidence preservation mode prevents software updates of the target mobile device.

5. The system of claim 1, wherein the evidence preservation mode prevents data expiration.

6. The system of claim 1, wherein the access module and the evidence preservation module do not extract any data from the target mobile device.

7. The system of claim 1, wherein the evidence preservation module preserves the at least a portion of the data of the target mobile device in the current configuration by creating a copy of the at least a portion of the data and storing the copy on the target mobile device.

8. The system of claim 7 wherein the copy is stored separately from the file system of the target mobile device.

9. The system of claim 1, wherein the at least one processor further includes an extraction module operable to extract data from the target mobile device.

10. The system of claim 1, wherein the evidence preservation module determines an amount of data which is present on the target mobile device which needs to be preserved.

11. The system of claim 10, wherein the amount of data is the amount of data which would be lost upon target mobile device shut down, updating, or clearing of temporary data.

12. A method of preserving evidence on a mobile device, the method comprising:
establishing a connection between a target mobile device and an investigator device; and
enabling an evidence preservation mode on the target mobile device by the investigator device, wherein the evidence preservation mode preserves at least a portion of target mobile device data in a current configuration.

13. The method of claim 12, wherein enabling the evidence preservation mode includes disabling an inactivity timer.

14. The method of claim 12, wherein enabling the evidence preservation mode includes disabling wiping of data from the target mobile device.

15. The method of claim 12, wherein enabling the evidence preservation mode includes disabling software updates of the target mobile device.

16. The method of claim 12, wherein enabling the evidence preservation mode includes disabling data expiration.

17. The method of claim 12, further comprising creating a copy of the at least a portion of the data and storing the copy on the target mobile device.

18. The system of claim 17, wherein the copy is stored separately from the file system of the target mobile device.

19. The method of claim 12, further comprising extracting the preserved data from the target mobile device.

20. The method of claim 12, wherein preserving the at least a portion of target mobile device data includes determining data that would be lost upon target mobile device shut down, updating, or clearing of temporary data.
